(19) United States
(12) Patent Application Publication
(10) Pub. No.: US 2019/0164444 A1
(43) Pub. Date: May 30, 2019

(54) ASSESSING A LEVEL OF COMPREHENSION OF A VIRTUAL LECTURE

(71) Applicant: The Board of Trustees of the University of Illinois, Urbana, IL (US)

(72) Inventors: Matthew Bramlet, Peoria, IL (US); Justin Douglas Drawz, Chicago, IL (US)

(73) Assignee: The Board of Trustees of the University of Illinois, Urbana, IL (US)

(21) Appl. No.: 16/199,077

(22) Filed: Nov. 23, 2018

Related U.S. Application Data
(60) Provisional application No. 62/590,561, filed on Nov. 25, 2017.

(51) Int. Cl. G09B 7/02; G09B 5/06; G09B 5/08; G06F 3/01; G06K 9/00; G06F 16/903

(52) U.S. Cl. CPC G09B 7/02; G09B 5/065; G06F 16/90335; G06F 3/011; G06K 9/00335; G09B 5/08

(57) ABSTRACT

A method includes a processing module of a computing system generating a virtual lecture environment utilizing a group of object representations, where some of the object representations are associated with corresponding three dimensional physical objects. The method continues with the processing module receiving educator lecture inputs during a lecture recording timeframe. The method continues with the processing module generating a learner assessment plan for assessing comprehension of a virtual lecture based on the educator lecture inputs. The method continues with the processing module linking the educator lecture inputs of the lecture recording timeframe with the virtual lecture environment to produce the virtual lecture. The method continues with the processing module receiving learner interaction information during a lecture playing timeframe of the virtual lecture. The method continues with the processing module determining a level of comprehension of the virtual lecture based on the learner assessment plan and the learner interaction information.

### CROSS-REFERENCE TO RELATED APPLICATIONS

The present U.S. Utility patent application claims priority pursuant to 35 U.S.C. § 119(e) to U.S. Provisional Application No. 62/590,561, entitled “VIRTUAL REALITY EDUCATION AND ASSESSMENT CREATION TOOL,” filed Nov. 25, 2017, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer systems and more particularly to computer systems providing educational and training content.

### Description of Related Art

Computer systems are known to communicate data, process data, and/or store data. Such computer systems include computing devices that range from wireless smart phones, laptops, tablets, personal computers (PC), work stations, personal three-dimensional (3-D) content viewers, and video game devices, to data centers where data servers store and provide access to digital content. Some of the digital content may be utilized to facilitate education and training. Examples of education and training related visual content includes electronic books, reference materials, training manuals, classroom coursework, lecture notes, research papers, images, video clips, sensor data, reports, etc. In general, a computing device includes a central processing unit (CPU), a memory system, user input/output interfaces, one or more sensors, peripheral device interfaces, and an interconnecting bus structure.

As is further known, there is a variety of existing educational modalities that utilize educational tools and techniques. For example, an educator delivers educational content to learners via an education tool of a recorded lecture that has built-in feedback prompts (e.g., questions, verification of viewing, etc.) From the responses to the feedback prompt is, the educator assess a degree of comprehension of the educational content and/or overall competence level of a learner. As a further example, the assessment tools includes games, simulation-based learning, and on-the-job training.

### BRIEF DESCRIPTION OF THE SEVERAL VIEWS OF THE DRAWING(S)

FIG. 1 is a schematic block diagram of an embodiment of a computing system in accordance with the present invention;

FIG. 2 is a schematic block diagram of an embodiment of a server of a computing system in accordance with the present invention;

FIG. 3 is a schematic block diagram of an embodiment of various computing devices of a computing system in accordance with the present invention;

FIGS. 4-7 are schematic block diagrams of another embodiment of a computing system illustrating a method for assessing a level of comprehension of a virtual lecture in accordance with the present invention; and

FIG. 8 is a logic diagram of an embodiment of a method for assessing a level of comprehension of a virtual lecture within a computing system in accordance with the present invention.

### DETAILED DESCRIPTION OF THE INVENTION

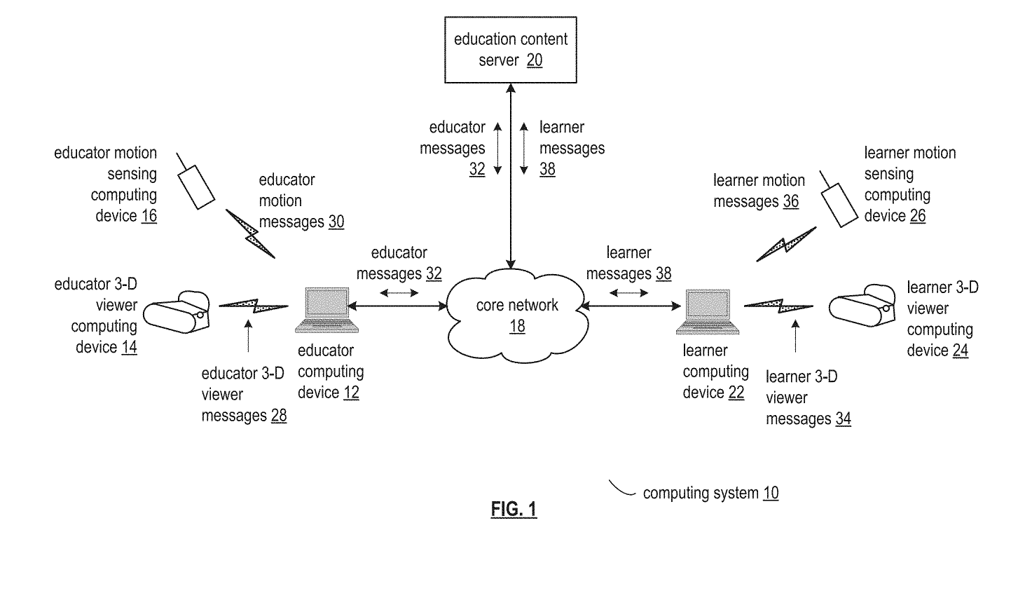

FIG. 1 is a schematic block diagram of an embodiment of a computing system 10 that includes an educator computing device 12, an educator 3-D viewer computing device 14, an educator motion sensing computing device 16, a core network 18, an education content server 20, a learner computing device 22, a learner 3-D viewer computing device 24, and/or a learner motion sensing computing device 26. The core network 18 includes at least one of the Internet, a public radio access network (RAN), and any private network.

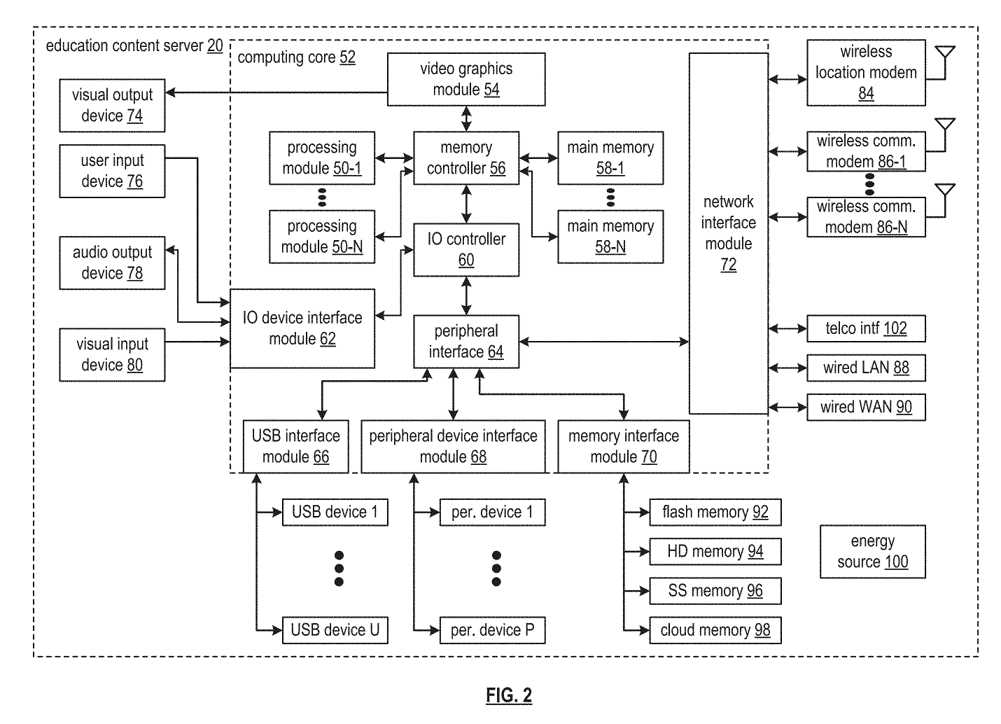

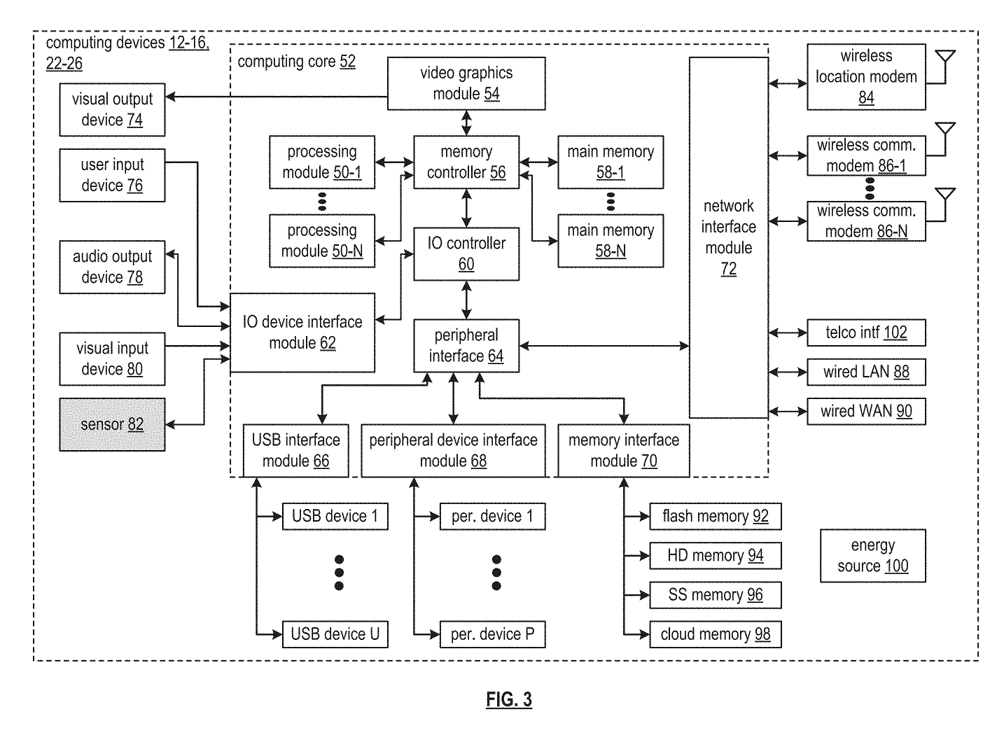

Each of the educator computing device 12, the educator 3-D viewer computing device 14, the educator motion sensing computing device 16, the education content server 20, the learner computing device 22, the learner 3-D viewer computing device 24, and the learner motion sensing computing device 26 include a computing device that includes a computing core. In general, a computing device is any electronic device that communicates data, processes data, represents data (e.g., user interface) and/or stores data. A further generality of a computing device is that it includes one or more of a central processing unit (CPU), a memory system, a sensor (e.g., internal or external), user input/output interfaces, peripheral device interfaces, communication elements, and/or an interconnecting bus structure. Embodiments of computing devices will be discussed in greater detail with reference to FIGS. 2-3.

As further specific examples, each of the computing devices may be a portable computing device and/or a fixed computing device. A portable computing device is one of a social networking device, a gaming device, a cell phone, a smart phone, a robot, a personal digital assistant, a digital music player, a digital video player, a laptop computer, a handheld computer, a tablet, a video game controller, and/or any other portable device that includes a computing core. A fixed computing device is one of a machine, a robot, a personal computer (PC), a computer server, a cable set-top box, a satellite receiver, a television set, a printer, a fax machine, home entertainment equipment, a video game console, and/or any type of home or office computing equipment that includes a computing core.

In an example of operation of the computing system 10, the educator computing device 12 communicates educator messages 32 with the education content server 20 to facilitate creating and storing of a lecture. For instance, the educator computing device 12 generates the educator messages 32 from educator 3-D viewer messages 28 from the educator 3-D viewer computing device 14 and based on receiving educator motion messages 30 from the educator motion sensing computing device 16. The educator 3-D viewer messages 28 include one or more of 3-D imaging information, speaker audio, microphone audio, hand motion sensor output, eye movement sensor output, etc. The educator 3-D viewer messages 28 may be communicated using wireline or wireless signals. The educator 3-D motion messages 30 include one or more of speaker audio, microphone audio, motion sensor output (e.g., hand motion), button press outputs, image sensor output, etc. The educator motion messages 30 may be communicated using the wireline or the wireless signals.

When generating the educator messages 32, the educator computing device 12 aggregates educator inputs from the educator 3-D viewer messages 28 and the educator motion messages 30 to produce the educator messages 32 to include one or more of educator 3-D viewer messages, educator 3-D motion messages, virtual environment information, digital object import data, assessment questions, assessment correct answers, assessment tasks, evaluation criteria for task performance, program command instructions, assessment summaries information, etc. The educator messages 32 may be communicated utilizing the wireline or the wireless signals. When utilizing the wireless signals, the device encodes the data in accordance with one or more wireless standards for local wireless data signals (e.g., Wi-Fi, Bluetooth, ZigBee) and/or for wide area wireless data signals (e.g., 2G, 3G, 4G, 5G, satellite, point-to-point, etc.) to produce the messages for transmission.

Having received the educator messages 32 that includes the educator inputs with regards to creating the virtual lecture in the 3-D environment, the education content server 20 generates and stores the virtual lecture (e.g., renders representations of physical objects associated with a virtual lecture environment in accordance with the educator inputs). For example, the education content server 20 renders the virtual lecture to include annotations and recorded speech of the educator while interacting via a virtual representation of the educator within the virtual lecture environment.

Having generated the virtual lecture, the education content server 20 generates the assessment plan for the lecture based on educator inputs, where the educator inputs may be received while recording the virtual lecture and/or received when recording a separate assessment session (e.g., the educator points to an object and asks a question requiring a response from the learner, the educator requests that the learner perform a task in the virtual environment interacting with the virtual objects, etc.). The assessment plan includes what type of feedback to obtain, how to obtain the feedback, how to evaluate the feedback to produce scoring information, and how to transform the scoring information into an assessment of the level of comprehension of the virtual lecture.

Having generated the assessment plan, the education content server 20 exchanges learner messages 38 with the learner computing device 22 during a virtual lecture consumption session by the learner utilizing one or more of the learner 3-D viewer computing device 24 and the learner motion sensing computing device 26. For example, the education content server 20 issues, via the core network 18, a streaming rendering of the virtual lecture within learner messages 38 to the learner computing device 22, where the learner computing device 22 outputs the streaming rendering of the virtual lecture within learner 3-D viewer messages 34 to the learner 3-D viewer computing device 24. In response to the streaming rendering, the learner computing device 22 captures learner inputs from learner 3-D viewer messages 34 received from the learner 3-D viewer computing device 24 and from learner motion messages 36 from the learner motion sensing computing device 26. Having captured the learner inputs, the learner computing device 22 sends the learner inputs within further learner messages 38 via the core network 18 to the education content server 20 to facilitate updating of the rendering of the virtual lecture (e.g., viewpoint movements, pointer movements, etc.) and to record feedback to one or more of a learning component and an assessment component associated with the virtual lecture.

The learner 3-D viewer messages 34 includes one or more of 3-D imaging information, speaker audio, microphone audio, head motion sensor output, eye movement sensor output, etc. The learner 3-D motion messages 36 includes one or more of speaker audio, microphone audio, motion sensor output (e.g., hand motion), button press outputs, image sensor output, etc. The learner messages 38 includes one or more of learner 3-D viewer messages, learner 3-D motion messages, assessment questions, assessment question responses, program command instructions (e.g., pause the virtual lecture, restart the virtual lecture, etc.), and assessment summary information. The learner 3-D viewer messages 34, the learner motion messages 36, and the learner messages 38 may be communicated via the wireline signals and/or the wireless signals.

Having exchanged the learner messages 38 during the virtual lecture and/or assessment, the education content server 20 generates an assessment of learning effectiveness based on the learner feedback to query is associated with the learning assessment plan. For example, the education content server 20 identifies query feedback in received learner messages 38 and compares the query feedback to correct response information of the learning assessment plan to produce scoring information. Having produced the scoring information, the education content server 20 evaluates the scoring information in accordance with the learning assessment plan to produce the assessment of the level of comprehension of the virtual lecture.

FIG. 2 is a schematic block diagram of an embodiment of the education content server 20 of FIG. 1. The server may include a computing core 52, one or more visual output devices 74 (e.g., video graphics display, touchscreen, LED, etc.), one or more user input devices 76 (e.g., keypad, keyboard, touchscreen, voice to text, a push button, a microphone, a card reader, a door position switch, a biometric input device, etc.), one or more audio output devices 78 (e.g., speaker(s), headphone jack, a motor, etc.), one or more visual input devices 80 (e.g., a still image camera, a video camera, photocell, etc.), one or more universal serial bus (USB) devices (USB devices 1-U), one or more peripheral devices (e.g., peripheral devices 1-P), one or more memory devices (e.g., local memory, one or more flash memory devices 92, one or more hard drive (HD) memories 94, one or more solid state (SS) memory devices 96, and/or cloud memory 98), one or more wireless location modems 84 (e.g., global positioning satellite (GPS), Wi-Fi, angle of arrival, time difference of arrival, signal strength, dedicated wireless location, etc.), one or more wireless communication modems 86-1 through 86-N (e.g., a cellular network transceiver, a wireless data network transceiver, a Wi-Fi transceiver, a Bluetooth transceiver, a 315 MHz transceiver, a zig bee transceiver, a 60 GHz transceiver, etc.), a telco interface 102 (e.g., to interface to a public switched telephone network), a wired local area network (LAN) 88 (e.g., optical, electrical), a wired wide area network (WAN) 90 (e.g., optical, electrical), and an energy source 100 (e.g., a battery, a solar power source, a fuel cell, a capacitor, a generator, mains power, backup power, etc.).

The computing core 52 includes a video graphics module 54, one or more processing modules 50-1 through 50-N, a memory controller 56, one or more main memories 58-1 through 58-N (e.g., RAM), one or more input/output (I/O) device interface modules 62, an input/output (I/O) controller 60, a peripheral interface 64, one or more USB interface modules 66, one or more network interface modules 72, one or more memory interface modules 70, and/or one or more peripheral device interface modules 68. A processing module is as defined at the end of the detailed description. Each of the interface modules 62, 66, 68, 70, and 72 includes a combination of hardware (e.g., connectors, wiring, etc.) and operational instructions stored on memory (e.g., driver software) that are executed by one or more of the processing modules 50-1 through 50-N and/or a processing circuit within the interface module. Each of the interface modules couples to one or more components of the edge nodes and premise nodes. For example, one of the IO device interface modules 62 couples to an audio output device 78. As another example, one of the memory interface modules 70 couples to flash memory 92 and another one of the memory interface modules 70 couples to cloud memory 98 (e.g., an on-line storage system and/or on-line backup system). In other embodiments, the servers may include more or less devices and modules than shown in this example embodiment of the premise node and edge node.

FIG. 3 is a schematic block diagram of an embodiment of the various devices of the computing system 10 FIG. 1, including the educator computing device 12, the educator 3-D viewer computing device 14, the educator motion sensing computing device 16, the education content server 20, the learner computing device 22, the learner 3-D viewer computing device 24, and the learner motion sensing computing device 26. The devices include the visual output device 74 of FIG. 2, the user input device 76 of FIG. 2, the audio output device 78 of FIG. 2, the visual input device 80 of FIG. 2, and one or more sensors 82 implemented internally and/or externally to the data device (e.g., a switch, a still camera, a video camera, servo motors associated with a camera, a position detector, a smoke detector, a gas detector, a motion sensor, an accelerometer, velocity detector, a compass, a gyro, a temperature sensor, a pressure sensor, an altitude sensor, a humidity detector, a moisture detector, an imaging sensor, a biometric sensor, an infrared sensor, an audio sensor, an ultrasonic sensor, a proximity detector, a magnetic field detector, a biomaterial detector, a radiation detector, a weight detector, a density detector, a chemical analysis detector, a fluid flow volume sensor, a DNA reader, a wind speed sensor, a wind direction sensor, an object detection sensor, an object identifier sensor, a motion recognition detector, a battery level detector, a room temperature sensor, a sound detector, a smoke detector, an intrusion detector, a motion detector, a door position sensor, a window position sensor, a sunlight detector, and medical category sensors including: a pulse rate monitor, a heart rhythm monitor, a breathing detector, a blood pressure monitor, a blood glucose level detector, blood type, an electrocardiogram sensor, a body mass detector, an imaging sensor, a microphone, body temperature, etc.).

The devices further include the computing core 52 of FIG. 2, the one or more universal serial bus (USB) devices (USB devices 1-U) of FIG. 2, the one or more peripheral devices (e.g., peripheral devices 1-P) of FIG. 2, the one or more memories of FIG. 2 (e.g., local memory, flash memories 92, HD memories 94, SS memories 96, and/or cloud memories 98), the one or more wireless location modems 84 of FIG. 2, the one or more wireless communication modems 86-1 through 86-N of FIG. 2, the telco interface 102 of FIG. 2, the wired local area network (LAN) 88 of FIG. 2, the wired wide area network (WAN) 90 of FIG. 2, and the energy source 100 of FIG. 2. In other embodiments, the devices may include more or less internal devices and modules than shown in this example embodiment of the various devices.

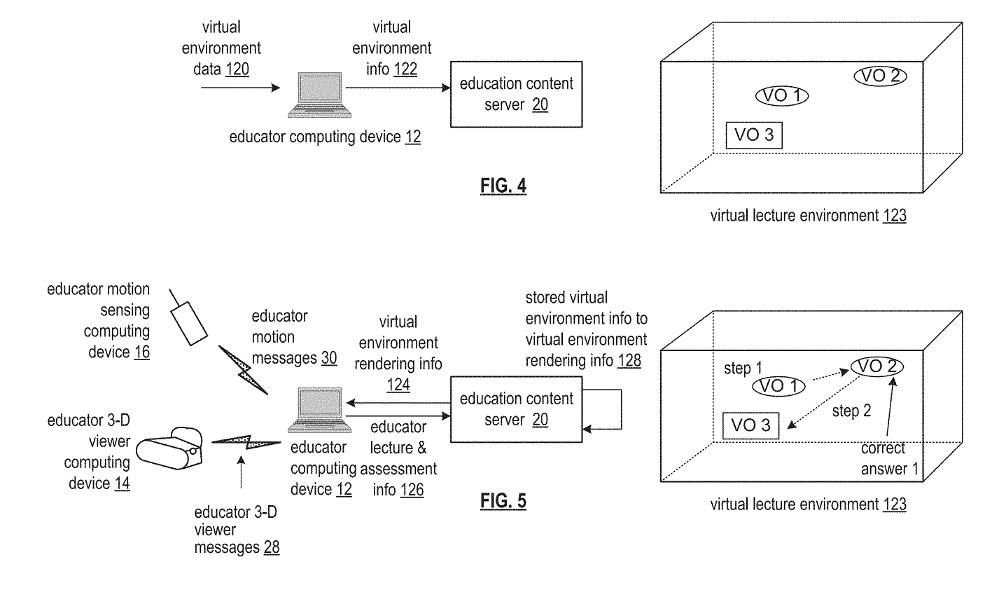

FIGS. 4-7 are schematic block diagrams of another embodiment of a computing system that includes the educator computing device 12 of FIG. 1, the education content server 20 of FIG. 1, a virtual lecture environment 123, the educator 3-D viewing computing device 14 of FIG. 1, the educator motion sensing computing device 16 of FIG. 1, the learner computing device 22 of FIG. 1, the learner 3-D viewer computing device 24 of FIG. 1, and the learner motion sensing computing device 26 of FIG. 1. Generally, this invention presents solutions where the computing system supports creation of a virtual lecture and assessment of a level of comprehension of the virtual lecture by a learner.

The creation of the virtual lecture and the assessment of the level of comprehension of the virtual lecture by the learner includes a series of steps. For example, a first step includes generating the virtual lecture environment 123 utilizing a group of object representations in accordance with object relationships between at least some of the object representations of the group of object representations, where at least some of the object representations are associated with corresponding three dimensional (3-D) physical objects. The object relationships includes one or more of 3-D spatial relationships and rules of interaction between at least some of the object representations of the group of object representations.

The generating the virtual lecture environment comprises one or more of selecting a plurality of object representations based on one or more lecture objectives, extracting an object representation from a learner input, recovering a virtual lecture environment template, extracting another object representation from an educator input, transforming a set of limited dimension representations of an object into a 3-D representation of an associated object representation, aggregating the selected plurality of object representations to produce the group of object representations, obtaining the 3-D spatial relationships and rules of interaction for the group of object representations, identifying a desired dimensional view, establishing a master set of future rendering rules for the group of object representations in accordance with the 3-D spatial relationships, the rules of interaction for the group of object representations, and the desired dimensional view, and rendering the group of object representations in accordance with the 3-D spatial relationships, the rules of interaction for the group of object representations, and the desired dimensional view.

As a specific example of the first step of the series of steps of creation of the virtual lecture environment and the assessment of the level of comprehension of the virtual environment by the learner, as illustrated in FIG. 4, the educator computing device 12 receives virtual environment data 120 (e.g., digital content, i.e., objects, data files; 2-D data, i.e., images, series of flat scans, etc.; and background environment data, i.e., room elements, special information, etc.). Having received the virtual environment data 120, the educator computing device 12 issues virtual environment information 122 to the education content server 20, where the virtual environment information 122 includes one or more of the virtual environment data 120, and various 3-D environment composite information (i.e., ready to render in combination with the virtual environment data. The education content server 20 obtains the 3-D spatial relationships and rules of interaction for the group of object representations associated with the virtual environment information 122 and renders the group of object representations in accordance with the 3-D spatial relationships and rules of interaction for the group of object representations to produce the virtual lecture environment 123.

The object representations include the digital description of physical aspects of a corresponding physical object, i.e., an operating room, a table, a ceiling light, etc., where at least one physical object describes a lecture environment, i.e., a scene where a virtual lecture is to take place such as a room, a building, an outdoor area, etc., or a digital description of anticipated physical aspects of a corresponding non-physical object, i.e., an imaginary avatar. The object relationships include one or more of spatial relationships between physical objects, rules of interaction between objects, i.e., allowed interaction, disallowed interaction, gravity effects, outside forces, etc., boundaries of an object representation of the physical scene of the virtual lecture, i.e., an operating room, a classroom, a laboratory, etc.

As a specific example of the rendering of the group of object representations in accordance with the 3-D spatial relationships and the rules of interaction for the group of object representations to produce the virtual lecture environment 123, the education content server 20 transforms a series of 2-D MRI slice scans into a single 3-D representation as a first object representation of the group of object representations, i.e., a virtual object 1 (VO 1). Having rendered the first object representation, the education content server 20 generates remaining object representations for other physical objects that are associated with the first object representation, i.e., physical objects that may be found within a surgical operating room, VO 2, VO 3. Having rendered the group of object representations, the education content server 20 renders the group of object representations with a representation of the surgical operating room to produce the virtual lecture environment 123.

A second step of the series of steps of creation of the virtual lecture environment and the assessment of the level of comprehension of the virtual environment by the learner includes receiving educator lecture inputs during a lecture recording timeframe, where the educator lecture inputs correspond to the virtual lecture environment. The educator lecture inputs include one or more of object representation information, object relationship information, educator head movement information, educator hand movement information, educator eye movement information, educator body movement information, text information, speech information, and a media file.

The receiving the educator lecture inputs includes initiating the lecture recording timeframe, sending a representation of the virtual lecture environment to an educator computing device, where the representation is in accordance with an educator viewpoint, receiving educator interaction information, where the educator interaction information corresponds to the representation of the virtual lecture environment, identifying timing aspects of the educator interaction information to produce timing correlation information, wherein the timing correlation information corresponds to the lecture recording timeframe, and combining the timing correlation information and the educator interaction information to produce the educator lecture inputs for storage.

As a specific example of the receiving the educator lecture inputs, as illustrated in FIG. 5, the education content server 20 issues virtual environment rendering information 124 to the educator computing device 12, where the educator computing device 12 processes the virtual environment rendering information 124 to produce a rendering of the virtual lecture environment 123 (e.g., including VO 1-3) and sends the rendering of the virtual lecture environment via educator 3-D viewer messages 28 to the educator 3-D viewer computing device 14 for viewing by the educator (e.g., 3-D imaging info, speaker audio). In response to the rendering of the virtual lecture environment, the educator computing device 12 receives further educator 3-D viewer messages 28 from the educator 3-D viewer computing device 14 that includes educator inputs (i.e., microphone audio, had motion sensor output, eye-movement sensor output, etc.) and receives educator motion messages 30 (i.e., hand motion sensor output, button press outputs, image sensor output, etc.) from the educator motion sensing computing device 16.

Having received the educator inputs, the educator computing device 12 issues educator lecture an assessment information 126 to the education content server 20, where the educator lecture and assessment information 126 includes one or more of motion sensor output, button press outputs, speech capture, text capture, and assessment plan information when capturing questions and correct answers associated with an assessment. The education content server 20 processes the educator lecture an assessment information 126 to perform stored virtual environment information to virtual environment rendering information 128, where the virtual environment rendering information includes updates to the virtual environment rendering information 124 for further viewing via the educator 3-D viewer computing device 14 and for the storage of the lecture by recording educator speech and educator head and hand movement information by time stamp within the lecture recording time frame. For instance, the educator, in a first step, the educator discusses VO 1, and in a second step discusses and highlights a movement of VO 2 to VO 3 within the virtual lecture environment 123.

A third step of the series of steps of creation of the virtual lecture environment and the assessment of the level of comprehension of the virtual environment by the learner includes generating a learner assessment plan for assessing comprehension of the virtual lecture based on the educator lecture inputs applied to the virtual lecture environment. The virtual lecture includes one or more of an educator object representation, a representation of the virtual lecture environment, viewpoint information within the virtual lecture environment, speech information, educator manipulation of object representations information, pointer information, highlighter information, and time synchronization information. The virtual lecture includes one or more of an educator object representation within the virtual lecture environment 123, one or more views (e.g., a viewpoint within the 3-D environment), educator audio (e.g., speech), positioning of other object representations within the virtual lecture environment, manipulation of the other object representations by the educator (e.g., movement of a pointer or highlighter utilized by the educator, etc.), time synchronization information of the views, the manipulation of the objects, the movement of the educator, and the educator audio recording.

The generating the learner assessment plan includes obtaining educator assessment inputs, where the educator assessment inputs includes one or more of lecture objectives, assessment scoring results versus level of comprehension information, learner identity versus expected assessment scoring results, questions, answers to the questions, tasks, task performance evaluation criteria, and further educator lecture inputs (e.g., may receive desires from a learner, assessment may be targeted for a particular learner or all learners or in between, the assessment may be captured while capturing the lecture and/or as a separate assessment after the lecture). The generating the learner assessment plan further includes identifying timing aspects of the educator assessment inputs to produce timing correlation information, where the timing correlation information corresponds to a virtual lecture timeframe of the virtual lecture, and where a duration of the virtual lecture timeframe is greater than or equal to a duration of the lecture recording timeframe (e.g., the assessment may require additional time beyond a formal portion of the lecture or the assessment may be embedded as the virtual lecture progresses). The generating the lecture assessment plan may further include applying the educator assessment inputs, the timing correlation information, and the educator lecture inputs to the virtual lecture environment to produce the learner assessment plan.

As a specific example of the generating of the assessment plan, as illustrated in FIG. 5, the education content server 20 receives the educator lecture and assessment information 126 including assessment plan information (e.g., questions, answers, tasks, task evaluation criteria) via the educator computing device 12 based on educator interaction information from one or more of the educator 3-D viewer computing device 14, the educator motion sensing computing device 16, and further inputs directly via the educator computing device 12 (e.g., text input including questions and answers). Having received the assessment plan information, the education content server 20 generates the assessment plan to include various questions, answers, tasks, task evaluation criteria, etc. For instance, the assessment plan includes asking a first question to identify one of the virtual objects, where a corresponding correct answer 1 includes identifying the virtual object 2.

A fourth step of the series of steps of creation of the virtual lecture environment and the assessment of the level of comprehension of the virtual environment by the learner includes linking the educator lecture inputs of the lecture recording timeframe with the virtual lecture environment to produce the virtual lecture, where the virtual lecture is associated with a lecture playing timeframe based on the lecture recording timeframe. The linking the educator lecture inputs during the lecture recording timeframe with the virtual lecture environment to produce the virtual lecture includes extracting assessment timing correlation information of the learner assessment plan, extracting educator timing correlation information of the educator lecture inputs, combining the educator lecture inputs and the learner assessment plan in accordance with the assessment timing correlation information and the educator timing correlation information to produce an interim virtual lecture, and applying the interim virtual lecture to the virtual lecture environment to produce the virtual lecture, where the lecture playing timeframe of the virtual lecture is based on timing correlation information of the interim virtual lecture and the lecture recording timeframe. As a specific example of the linking the educator lecture inputs to the virtual lecture environment, as illustrated in FIG. 5, the education content server 20 integrates steps and timing aspects of the assessment plan and the educator lecture inputs within the virtual lecture environment 123 to produce the virtual lecture. For instance, the education content server 20 generates a composite rendering that includes the educator object representation in accordance with the educator lecture inputs and the learner assessment plan within the virtual lecture environment for the lecture playing timeframe to produce the virtual lecture.

A fifth step of the series of steps of creation of the virtual lecture environment and the assessment of the level of comprehension of the virtual environment by the learner includes receiving learner interaction information during a lecture playing timeframe, where the learner interaction information corresponds to the virtual lecture. The lecture playing timeframe includes one or more of a timeframe to playback the virtual lecture in substantially a same amount of time as the lecture recording timeframe, a time frame to playback the virtual lecture with embedded queries and query responses in accordance with the learner assessment plan, and a timeframe to receive learner interaction information associated with one or more elements of the learner assessment plan. The learner interaction information includes one or more of additional object representation information additional object relationship information, learner head movement information, learner hand movement information, learner eye movement information, learner body movement information, text response information, query response information, executed task information, virtual lecture pacing information, virtual lecture historical execution information, speech response information, and a media response file.

The receiving of the learner interaction information during the lecture playing timeframe includes initiating the lecture playing timeframe, sending a representation of the virtual lecture to a learner computing device, where the representation is in accordance with a learner viewpoint, receiving learner lecture inputs, where the learner lecture inputs corresponds to the representation of the virtual lecture, identifying timing aspects of the learner lecture inputs to produce timing correlation information, where the timing correlation information corresponds to the lecture playing timeframe, and combining the timing correlation information and the learner lecture inputs to produce the learner interaction information.

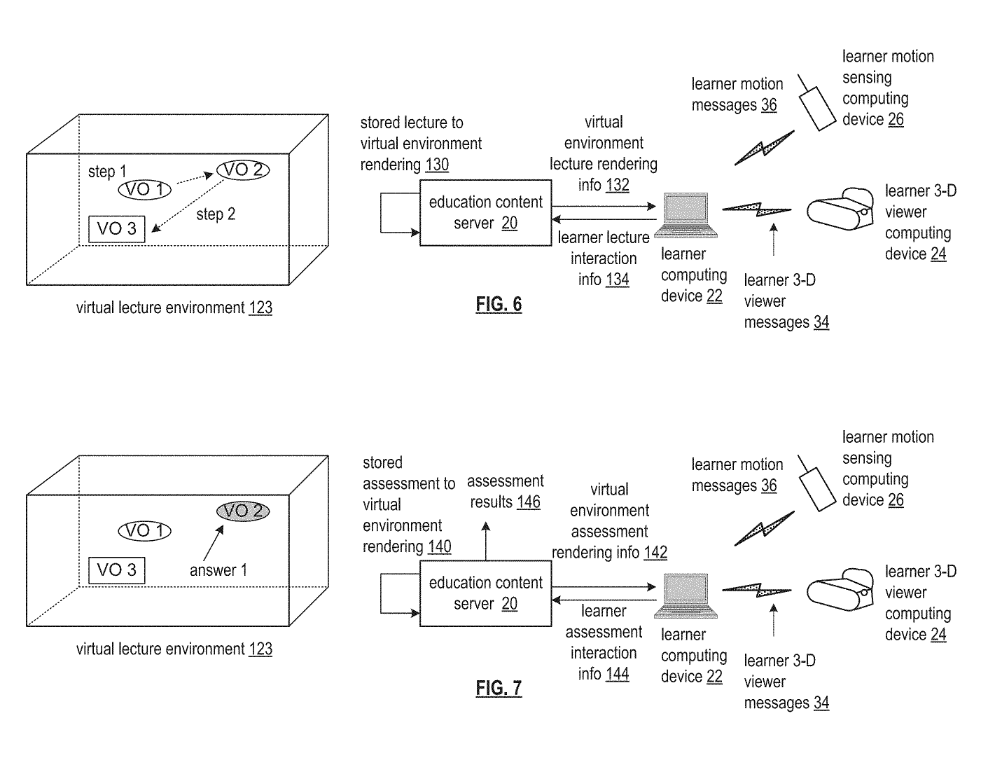

As a specific example of the receiving of the learner interaction information, as illustrated in FIG. 6, the education content server 20 performs a stored lecture to the virtual environment rendering 130 and issues virtual environment lecture rendering information 132 to the learner computing device 22, where the virtual environment lecture rendering information 132 includes the current rendering of the virtual lecture environment 123. The learner computing device 22 sends the current rendering of the virtual lecture environment via learner 3-D viewer messages 34 to the learner 3-D viewer computing device 24 to facilitate 3-D viewing by the learner. For instance, the learner 3-D viewer messages 34 includes 3-D imaging information and speaker audio that includes audio of the educator from the virtual lecture.

Having output the current rendering of the virtual lecture environment, the learner computing device 22 receives further learner 3-D viewer messages 34 from the learner 3-D viewer computing device 24 (e.g., microphone audio, head motion sensor output, eye-movement sensor output, etc.) and receives learner motion messages 36 from the learner motion sensing computing device 26 (e.g., hand motion sensor output, button press outputs, image sensor output, lecture control information such as pause, stop, rewind, fast-forward, skip forward, skip backwards, play, and other commands etc.) for generating learner lecture interaction information 134 to provide to the education content server 20. The education content server 20 updates the virtual environment lecture rendering information 132 based on the learner lecture interaction information 134 (e.g., to illustrate movement by the learner and to capture feedback to queries associated with the learner assessment plan) and facilitates storage of the learner interaction information to include timestamps that correspond to aspects of the learner interaction information within the learner lecture playing timeframe.

A sixth step of the series of steps of creation of the virtual lecture environment and the assessment of the level of comprehension of the virtual environment by the learner includes evaluating learner assessment inputs in accordance with the learner assessment plan to determine a level of comprehension of the virtual lecture. The evaluating the learner assessment inputs includes extracting the learner assessment inputs from one or more of the learner interaction information associated with the lecture playing timeframe and subsequent learner interaction information associated with an assessment timeframe, interpreting the learner assessment inputs to produce a group of scorable responses, where each scoreable response corresponds to a scoreable query of a plurality of scoreable queries of the learner assessment plan, determining a score for each scoreable query of the plurality of scoreable queries utilizing the group of scoreable responses and a scoring approach of the learner assessment plan to produce a plurality of scores (e.g., scoring approach: a weighting system, scoring when not enough scoreable responses have been received, etc.) and transforming the plurality of scores based on a level of comprehension determination approach of the learner assessment plan to produce the level of comprehension of the virtual lecture.

As a specific example of the evaluating the learner assessment inputs to determine the level of comprehension of the virtual lecture, as illustrated in FIG. 6, the education content server 20 extracts the learner assessment inputs from the learner assessment information when the assessment is performed during the virtual lecture (e.g., during the virtual lecture virtual lecture playing timeframe). As another specific example, as illustrated in FIG. 7, the education content server 20 issues virtual environment assessment rendering information 142, in accordance with stored assessment to virtual environment rendering 140, to the learner computing device 22 and in response receives learner assessment interaction information 144 (i.e., the learner answer is VO 1) when the assessment is performed after the virtual lecture (e.g., the learner must perform tasks subsequent to viewing the virtual lecture or answer questions after the virtual lecture utilizing the one or more of the learner computing device 22, the learner motion sensing computing device 26 and the learner 3-D viewer computing device 24).

Having received the learner assessment interaction information 144 and/or the learner assessment inputs, the education content server 20 interprets feedback (e.g., compares answers to correct answers, compares task performance information to required task performance information, etc.) from the learner assessment interaction information 144 and/or the learner assessment inputs to produce learner answers and generates a score based on comparing the learner answers to its corresponding correct answers of the learner assessment plan to produce the level of comprehension of the virtual lecture for output as assessment results 146.

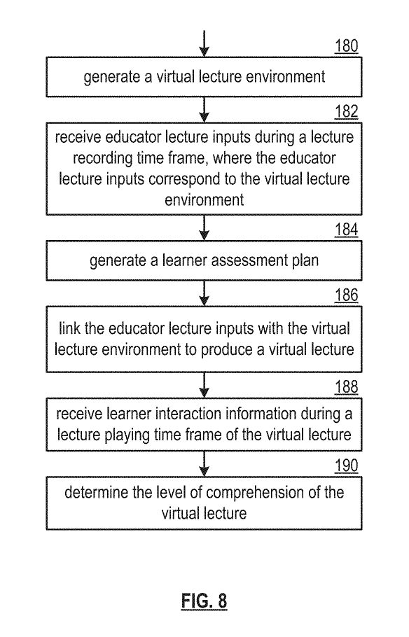

FIG. 8 is a logic diagram of an embodiment of a method for assessing the level of comprehension of a virtual lecture within a computing system (e.g., the computing system 10 of FIG. 1). In particular, a method is presented in conjunction with one or more functions and features described in conjunction with FIGS. 1-3, and also FIGS. 4-7. The method includes step 180 where a processing module of one or more processing modules of one or more computing devices within the computing system generates a virtual lecture environment utilizing a group of object representations in accordance with object relationships between at least some of the object representations of the group of object representations, where at least some of the object representations are associated with corresponding three dimensional (3-D) physical objects, and where the object relationships includes one or more of 3-D spatial relationships and rules of interaction between at least some of the object representations of the group of object representations.

The generating the virtual lecture environment includes one or more of selecting a plurality of object representations based on one or more lecture objectives, extracting an object representation from a learner input, recovering a virtual lecture environment template, extracting another object representation from an educator input, transforming a set of limited dimension representations of an object into a 3-D representation of an associated object representation, aggregating the selected plurality of object representations to produce the group of object representations, obtaining the 3-D spatial relationships and rules of interaction for the group of object representations, identifying a desired dimensional view, establishing a master set of future rendering rules for the group of object representations in accordance with the 3-D spatial relationships, the rules of interaction for the group of object representations, and the desired dimensional view, and rendering the group of object representations in accordance with the 3-D spatial relationships, the rules of interaction for the group of object representations, and the desired dimensional view.

The method continues at step 182 where the processing module receives educator lecture inputs during a lecture recording timeframe, where the educator lecture inputs correspond to the virtual lecture environment. The receiving the educator lecture inputs includes initiating the lecture recording timeframe, sending a representation of the virtual lecture environment to an educator computing device, where the representation is in accordance with an educator viewpoint, receiving educator interaction information, where the educator interaction information corresponds to the representation of the virtual lecture environment, identifying timing aspects of the educator interaction information to produce timing correlation information, where the timing correlation information corresponds to the lecture recording timeframe, and combining the timing correlation information and the educator interaction information to produce the educator lecture inputs.

The method continues at step 184 where the processing module generates a learner assessment plan for assessing comprehension of a virtual lecture based on the educator lecture inputs applied to the virtual lecture environment. The generating of the learner assessment plan includes obtaining educator assessment inputs, where the educator assessment inputs includes one or more of lecture objectives, assessment scoring results versus level of comprehension information, learner identity versus expected assessment scoring results, questions, answers to the questions, tasks, task performance evaluation criteria, and further educator lecture inputs, identifying timing aspects of the educator assessment inputs to produce timing correlation information, where the timing correlation information corresponds to a virtual lecture timeframe of the virtual lecture, and where a duration of the virtual lecture timeframe is greater than or equal to a duration of the lecture recording timeframe, and applying the educator assessment inputs, the timing correlation information, and the educator lecture inputs to the virtual lecture environment to produce the learner assessment plan.

The method continues at step 186 where the processing module links the educator lecture inputs of the lecture recording timeframe with the virtual lecture environment to produce the virtual lecture, where the virtual lecture is associated with a lecture playing timeframe based on the lecture recording timeframe. The linking of the educator lecture inputs during the lecture recording timeframe with the virtual lecture environment to produce the virtual lecture includes extracting assessment timing correlation information of the learner assessment plan, extracting educator timing correlation information of the educator lecture inputs, combining the educator lecture inputs and the learner assessment plan in accordance with the assessment timing correlation information and the educator timing correlation information to produce an interim virtual lecture, and applying the interim virtual lecture to the virtual lecture environment to produce the virtual lecture, wherein the lecture playing timeframe of the virtual lecture is based on timing correlation information of the interim virtual lecture and the lecture recording timeframe.

The method continues at step 188 where the processing module receives learner interaction information during a lecture playing timeframe, where the learner interaction information corresponds to the virtual lecture. The receiving of the learner interaction information during the lecture playing timeframe includes initiating the lecture playing timeframe, sending a representation of the virtual lecture to a learner computing device, where the representation is in accordance with a learner viewpoint, receiving learner lecture inputs, where the learner lecture inputs corresponds to the representation of the virtual lecture, identifying timing aspects of the learner lecture inputs to produce timing correlation information, where the timing correlation information corresponds to the lecture playing timeframe, and combining the timing correlation information and the learner lecture inputs to produce the learner interaction information.

The method continues at step 190 where the processing module evaluates learner assessment inputs in accordance with the learner assessment plan to determine a level of comprehension of the virtual lecture. The evaluating the learner assessment inputs includes extracting the learner assessment inputs from one or more of the learner interaction information associated with the lecture playing timeframe and subsequent learner interaction information associated with an assessment timeframe, interpreting the learner assessment inputs to produce a group of scorable responses, where each scoreable response corresponds to a scoreable query of a plurality of scoreable queries of the learner assessment plan, determining a score for each scoreable query of the plurality of scoreable queries utilizing the group of scoreable responses and a scoring approach of the learner assessment plan to produce a plurality of scores, and transforming the plurality of scores based on a level of comprehension determination approach of the learner assessment plan to produce the level of comprehension of the virtual lecture.

The method described above in conjunction with the processing module can alternatively be performed by other modules of the computing system 10 of FIG. 1 or by other devices. In addition, at least one memory section (e.g., a computer readable memory, a non-transitory computer readable storage medium, a non-transitory computer readable memory organized into a first memory element, a second memory element, a third memory element, a fourth element section, a fifth memory element, a sixth memory element, etc.) that stores operational instructions can, when executed by one or more processing modules of the one or more computing devices of the computing system 10, cause the one or more computing devices to perform any or all of the method steps described above.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more computing devices of a computing system, the method comprises:
generating a virtual lecture environment utilizing a group of object representations in accordance with object relationships between at least some of the object representations of the group of object representations, wherein at least some of the object representations are associated with corresponding three dimensional (3-D) physical objects, and wherein the object relationships includes one or more of 3-D spatial relationships and rules of interaction between at least some of the object representations of the group of object representations;
receiving educator lecture inputs during a lecture recording timeframe, wherein the educator lecture inputs correspond to the virtual lecture environment;
generating a learner assessment plan for assessing comprehension of a virtual lecture based on the educator lecture inputs applied to the virtual lecture environment;
linking the educator lecture inputs of the lecture recording timeframe with the virtual lecture environment to produce the virtual lecture, wherein the virtual lecture is associated with a lecture playing timeframe based on the lecture recording timeframe;
receiving learner interaction information during a lecture playing timeframe, wherein the learner interaction information corresponds to the virtual lecture; and
evaluating learner assessment inputs in accordance with the learner assessment plan to determine a level of comprehension of the virtual lecture.

2. The method of claim 1, wherein the educator lecture inputs comprise one or more of:
object representation information;
object relationship information;
educator head movement information;
educator hand movement information;
educator eye movement information;
educator body movement information;
text information;
speech information; and
a media file.

3. The method of claim 1, wherein the virtual lecture comprises one or more of:
an educator object representation;
a representation of the virtual lecture environment;
viewpoint information within the virtual lecture environment;
speech information;
educator manipulation of object representations information;
pointer information;
highlighter information; and
time synchronization information.

4. The method of claim 1, wherein the learner interaction information comprises one or more of:
additional object representation information;
additional object relationship information;
learner head movement information;
learner hand movement information;
learner eye movement information;
learner body movement information;
text response information;
query response information;
executed task information;
virtual lecture pacing information;
virtual lecture historical execution information;
speech response information; and
a media response file.

5. The method of claim 1, wherein the generating the virtual lecture environment comprises one or more of:
selecting a plurality of object representations based on one or more lecture objectives;
extracting an object representation from a learner input;
recovering a virtual lecture environment template;
extracting another object representation from an educator input;
transforming a set of limited dimension representations of an object into a 3-D representation of an associated object representation;
aggregating the selected plurality of object representations to produce the group of object representations;
obtaining the 3-D spatial relationships and rules of interaction for the group of object representations;
identifying a desired dimensional view;
establishing a master set of future rendering rules for the group of object representations in accordance with the 3-D spatial relationships, the rules of interaction for the group of object representations, and the desired dimensional view; and
rendering the group of object representations in accordance with the 3-D spatial relationships, the rules of interaction for the group of object representations, and the desired dimensional view.

6. The method of claim 1, wherein the receiving the educator lecture inputs comprises:
initiating the lecture recording timeframe;
sending a representation of the virtual lecture environment to an educator computing device, wherein the representation is in accordance with an educator viewpoint;
receiving educator interaction information, wherein the educator interaction information corresponds to the representation of the virtual lecture environment;
identifying timing aspects of the educator interaction information to produce timing correlation information, wherein the timing correlation information corresponds to the lecture recording timeframe; and
combining the timing correlation information and the educator interaction information to produce the educator lecture inputs.

7. The method of claim 1, wherein the generating the learner assessment plan comprises:
obtaining educator assessment inputs, wherein the educator assessment inputs includes one or more of lecture objectives, assessment scoring results versus level of comprehension information, learner identity versus expected assessment scoring results, questions, answers to the questions, tasks, task performance evaluation criteria, and further educator lecture inputs;
identifying timing aspects of the educator assessment inputs to produce timing correlation information, wherein the timing correlation information corresponds to a virtual lecture timeframe of the virtual lecture, and wherein a duration of the virtual lecture timeframe is greater than or equal to a duration of the lecture recording timeframe; and
applying the educator assessment inputs, the timing correlation information, and the educator lecture inputs to the virtual lecture environment to produce the learner assessment plan.

8. The method of claim 1, wherein the linking the educator lecture inputs during the lecture recording timeframe with the virtual lecture environment to produce the virtual lecture comprises:
extracting assessment timing correlation information of the learner assessment plan;
extracting educator timing correlation information of the educator lecture inputs;
combining the educator lecture inputs and the learner assessment plan in accordance with the assessment timing correlation information and the educator timing correlation information to produce an interim virtual lecture; and
applying the interim virtual lecture to the virtual lecture environment to produce the virtual lecture, wherein the lecture playing timeframe of the virtual lecture is based on timing correlation information of the interim virtual lecture and the lecture recording timeframe.

9. The method of claim 1, wherein the receiving the learner interaction information during the lecture playing timeframe comprises:
initiating the lecture playing timeframe;
sending a representation of the virtual lecture to a learner computing device, wherein the representation is in accordance with a learner viewpoint;
receiving learner lecture inputs, wherein the learner lecture inputs corresponds to the representation of the virtual lecture;
identifying timing aspects of the learner lecture inputs to produce timing correlation information, wherein the timing correlation information corresponds to the lecture playing timeframe; and
combining the timing correlation information and the learner lecture inputs to produce the learner interaction information.

10. The method of claim 1, wherein the evaluating the learner assessment inputs comprises:
extracting the learner assessment inputs from one or more of the learner interaction information associated with the lecture playing timeframe and subsequent learner interaction information associated with an assessment timeframe;
interpreting the learner assessment inputs to produce a group of scorable responses, wherein each scoreable response corresponds to a scoreable query of a plurality of scoreable queries of the learner assessment plan;
determining a score for each scoreable query of the plurality of scoreable queries utilizing the group of scoreable responses and a scoring approach of the learner assessment plan to produce a plurality of scores; and
transforming the plurality of scores based on a level of comprehension determination approach of the learner assessment plan to produce the level of comprehension of the virtual lecture.

11. A computing device of a computing system, the computing device comprises:
an interface;
a local memory; and
a processing module operably coupled to the interface and the local memory, wherein the processing module functions to:
generate a virtual lecture environment utilizing a group of object representations in accordance with object relationships between at least some of the object representations of the group of object representations, wherein at least some of the object representations are associated with corresponding three dimensional (3-D) physical objects, and wherein the object relationships includes one or more of 3-D spatial relationships and rules of interaction between at least some of object representations of the group of object representations;
receive, via the interface, educator lecture inputs during a lecture recording timeframe, wherein the educator lecture inputs correspond to the virtual lecture environment;
generate a learner assessment plan for assessing comprehension of a virtual lecture based on the educator lecture inputs applied to the virtual lecture environment;
link the educator lecture inputs of the lecture recording timeframe with the virtual lecture environment to produce the virtual lecture, wherein the virtual lecture is associated with a lecture playing timeframe based on the lecture recording timeframe;
receive, via the interface, learner interaction information during a lecture playing timeframe, wherein the learner interaction information corresponds to the virtual lecture; and
evaluate learner assessment inputs in accordance with the learner assessment plan to determine a level of comprehension of the virtual lecture.

12. The computing device of claim 11, wherein the educator lecture inputs comprise one or more of:
object representation information;
object relationship information;
educator head movement information;
educator hand movement information;
educator eye movement information;
educator body movement information;
text information;
speech information; and
a media file.

13. The computing device of claim 11, wherein the virtual lecture comprises one or more of:
an educator object representation;
a representation of the virtual lecture environment;
viewpoint information within the virtual lecture environment;
speech information;
educator manipulation of object representations information;
pointer information;
highlighter information; and
time synchronization information.

14. The computing device of claim 11, wherein the learner interaction information comprises one or more of:
additional object representation information;
additional object relationship information;
learner head movement information;
learner hand movement information;
learner eye movement information;
learner body movement information;
text response information;
query response information;
executed task information;
virtual lecture pacing information;
virtual lecture historical execution information;
speech response information; and
a media response file.

15. The computing device of claim 11, wherein the processing module functions to generate the virtual lecture environment by one or more of:
selecting a plurality of object representations based on one or more lecture objectives;
extracting an object representation from a learner input;
recovering, from the local memory, a virtual lecture environment template;
extracting another object representation from an educator input;
transforming a set of limited dimension representations of an object into a 3-D representation of an associated object representation;
aggregating the selected plurality of object representations to produce the group of object representations;
obtaining the 3-D spatial relationships and rules of interaction for the group of object representations;
identifying a desired dimensional view;
establishing a master set of future rendering rules for the group of object representations in accordance with the 3-D spatial relationships, the rules of interaction for the group of object representations, and the desired dimensional view; and
rendering the group of object representations in accordance with the 3-D spatial relationships, the rules of interaction for the group of object representations, and the desired dimensional view.

16. The computing device of claim 11, wherein the processing module functions to receive the educator lecture inputs by:
initiating the lecture recording timeframe;
sending, via the interface, a representation of the virtual lecture environment to an educator computing device, wherein the representation is in accordance with an educator viewpoint;
receiving, via the interface, educator interaction information, wherein the educator interaction information corresponds to the representation of the virtual lecture environment;
identifying timing aspects of the educator interaction information to produce timing correlation information, wherein the timing correlation information corresponds to the lecture recording timeframe; and
combining the timing correlation information and the educator interaction information to produce the educator lecture inputs.

17. The computing device of claim 11, wherein the processing module functions to generate the learner assessment plan by:
obtaining educator assessment inputs, wherein the educator assessment inputs includes one or more of lecture objectives, assessment scoring results versus level of comprehension information, learner identity versus expected assessment scoring results, questions, answers to the questions, tasks, task performance evaluation criteria, and further educator lecture inputs;
identifying timing aspects of the educator assessment inputs to produce timing correlation information, wherein the timing correlation information corresponds to a virtual lecture timeframe of the virtual lecture, and wherein a duration of the virtual lecture timeframe is greater than or equal to a duration of the lecture recording timeframe; and
applying the educator assessment inputs, the timing correlation information, and the educator lecture inputs to the virtual lecture environment to produce the learner assessment plan.

18. The computing device of claim 11, wherein the processing module functions to link the educator lecture inputs during the lecture recording timeframe with the virtual lecture environment to produce the virtual lecture by:
extracting assessment timing correlation information of the learner assessment plan;
extracting educator timing correlation information of the educator lecture inputs;
combining the educator lecture inputs and the learner assessment plan in accordance with the assessment timing correlation information and the educator timing correlation information to produce an interim virtual lecture; and
applying the interim virtual lecture to the virtual lecture environment to produce the virtual lecture, wherein the lecture playing timeframe of the virtual lecture is based on timing correlation information of the interim virtual lecture and the lecture recording timeframe.

19. The computing device of claim 11, wherein the processing module functions to receive the learner interaction information during the lecture playing timeframe by:
initiating the lecture playing timeframe;
sending, via the interface, a representation of the virtual lecture to a learner computing device, wherein the representation is in accordance with a learner viewpoint;
receiving, via the interface, learner lecture inputs, wherein the learner lecture inputs corresponds to the representation of the virtual lecture;
identifying timing aspects of the learner lecture inputs to produce timing correlation information, wherein the timing correlation information corresponds to the lecture playing timeframe; and
combining the timing correlation information and the learner lecture inputs to produce the learner interaction information.

20. The computing device of claim 11, wherein the processing module functions to evaluate the learner assessment inputs by:
extracting the learner assessment inputs from one or more of the learner interaction information associated with the lecture playing timeframe and subsequent learner interaction information associated with an assessment timeframe;
interpreting the learner assessment inputs to produce a group of scorable responses, wherein each scoreable response corresponds to a scoreable query of a plurality of scoreable queries of the learner assessment plan;
determining a score for each scoreable query of the plurality of scoreable queries utilizing the group of scoreable responses and a scoring approach of the learner assessment plan to produce a plurality of scores; and
transforming the plurality of scores based on a level of comprehension determination approach of the learner assessment plan to produce the level of comprehension of the virtual lecture.

21. A computer readable memory comprises:
a first memory element that stores operational instructions that, when executed by a processing module, causes the processing module to:
generate a virtual lecture environment utilizing a group of object representations in accordance with object relationships between at least some of the object representations of the group of object representations, wherein at least some of the object representations are associated with corresponding three dimensional (3-D) physical objects, and wherein the object relationships includes one or more of 3-D spatial relationships and rules of interaction between at least some of object representations of the group of object representations;
a second memory element that stores operational instructions that, when executed by the processing module, causes the processing module to:
receive educator lecture inputs during a lecture recording timeframe, wherein the educator lecture inputs correspond to the virtual lecture environment;
a third memory element that stores operational instructions that, when executed by the processing module, causes the processing module to:
generate a learner assessment plan for assessing comprehension of a virtual lecture based on the educator lecture inputs applied to the virtual lecture environment;
a fourth memory element that stores operational instructions that, when executed by the processing module, causes the processing module to:
link the educator lecture inputs of the lecture recording timeframe with the virtual lecture environment to produce the virtual lecture, wherein the virtual lecture is associated with a lecture playing timeframe based on the lecture recording timeframe;
a fifth memory element that stores operational instructions that, when executed by the processing module, causes the processing module to:
receive learner interaction information during a lecture playing timeframe, wherein the learner interaction information corresponds to the virtual lecture; and
a sixth memory element that stores operational instructions that, when executed by the processing module, causes the processing module to:
evaluate learner assessment inputs in accordance with the learner assessment plan to determine a level of comprehension of the virtual lecture.

22. The computer readable memory of claim 21, wherein the educator lecture inputs comprise one or more of:
object representation information;
object relationship information;
educator head movement information;
educator hand movement information;
educator eye movement information;
educator body movement information;
text information;
speech information; and
a media file.

23. The computer readable memory of claim 21, wherein the virtual lecture comprises one or more of:
an educator object representation;
a representation of the virtual lecture environment;
viewpoint information within the virtual lecture environment;
speech information;
educator manipulation of object representations information;
pointer information;
highlighter information; and
time synchronization information.

24. The computer readable memory of claim 21, wherein the learner interaction information comprises one or more of:
additional object representation information;
additional object relationship information;
learner head movement information;
learner hand movement information;
learner eye movement information;
learner body movement information;
text response information;
query response information;
executed task information;
virtual lecture pacing information;
virtual lecture historical execution information;
speech response information; and
a media response file.

25. The computer readable memory of claim 21, wherein the processing module functions to execute the operational instructions stored by the first memory element to cause the processing module to generate the virtual lecture environment by one or more of:
selecting a plurality of object representations based on one or more lecture objectives;
extracting an object representation from a learner input;
recovering a virtual lecture environment template;
extracting another object representation from an educator input;
transforming a set of limited dimension representations of an object into a 3-D representation of an associated object representation;
aggregating the selected plurality of object representations to produce the group of object representations;
obtaining the 3-D spatial relationships and rules of interaction for the group of object representations;
identifying a desired dimensional view;
establishing a master set of future rendering rules for the group of object representations in accordance with the 3-D spatial relationships, the rules of interaction for the group of object representations, and the desired dimensional view; and
rendering the group of object representations in accordance with the 3-D spatial relationships, the rules of interaction for the group of object representations, and the desired dimensional view.

26. The computer readable memory of claim 21, wherein the processing module functions to execute the operational instructions stored by the second memory element to cause the processing module to receive the educator lecture inputs by:
initiating the lecture recording timeframe;
sending a representation of the virtual lecture environment to an educator computing device, wherein the representation is in accordance with an educator viewpoint;
receiving educator interaction information, wherein the educator interaction information corresponds to the representation of the virtual lecture environment;
identifying timing aspects of the educator interaction information to produce timing correlation information, wherein the timing correlation information corresponds to the lecture recording timeframe; and
combining the timing correlation information and the educator interaction information to produce the educator lecture inputs.

27. The computer readable memory of claim 21, wherein the processing module functions to execute the operational instructions stored by the third memory element to cause the processing module to generate the learner assessment plan by:
obtaining educator assessment inputs, wherein the educator assessment inputs includes one or more of lecture objectives, assessment scoring results versus level of comprehension information, learner identity versus expected assessment scoring results, questions, answers to the questions, tasks, task performance evaluation criteria, and further educator lecture inputs;
identifying timing aspects of the educator assessment inputs to produce timing correlation information, wherein the timing correlation information corresponds to a virtual lecture timeframe of the virtual lecture, and wherein a duration of the virtual lecture timeframe is greater than or equal to a duration of the lecture recording timeframe; and
applying the educator assessment inputs, the timing correlation information, and the educator lecture inputs to the virtual lecture environment to produce the learner assessment plan.

28. The computer readable memory of claim 21, wherein the processing module functions to execute the operational instructions stored by the fourth memory element to cause the processing module to link the educator lecture inputs during the lecture recording timeframe with the virtual lecture environment to produce the virtual lecture by:
extracting assessment timing correlation information of the learner assessment plan;
extracting educator timing correlation information of the educator lecture inputs;
combining the educator lecture inputs and the learner assessment plan in accordance with the assessment timing correlation information and the educator timing correlation information to produce an interim virtual lecture; and
applying the interim virtual lecture to the virtual lecture environment to produce the virtual lecture, wherein the lecture playing timeframe of the virtual lecture is based on timing correlation information of the interim virtual lecture and the lecture recording timeframe.

29. The computer readable memory of claim 21, wherein the processing module functions to execute the operational instructions stored by the fifth memory element to cause the processing module to receive the learner interaction information during the lecture playing timeframe by:
initiating the lecture playing timeframe;
sending a representation of the virtual lecture to a learner computing device, wherein the representation is in accordance with a learner viewpoint;
receiving learner lecture inputs, wherein the learner lecture inputs corresponds to the representation of the virtual lecture;
identifying timing aspects of the learner lecture inputs to produce timing correlation information, wherein the timing correlation information corresponds to the lecture playing timeframe; and
combining the timing correlation information and the learner lecture inputs to produce the learner interaction information.

30. The computer readable memory of claim 21, wherein the processing module functions to execute the operational instructions stored by the sixth memory element to cause the processing module to evaluate the learner assessment inputs by:
extracting the learner assessment inputs from one or more of the learner interaction information associated with the lecture playing timeframe and subsequent learner interaction information associated with an assessment timeframe;
interpreting the learner assessment inputs to produce a group of scorable responses, wherein each scoreable response corresponds to a scoreable query of a plurality of scoreable queries of the learner assessment plan;
determining a score for each scoreable query of the plurality of scoreable queries utilizing the group of scoreable responses and a scoring approach of the learner assessment plan to produce a plurality of scores; and
transforming the plurality of scores based on a level of comprehension determination approach of the learner assessment plan to produce the level of comprehension of the virtual lecture.
